(19) United States
(12) Patent Application Publication
(10) Pub. No.: US 2026/0290073 A1
(43) Pub. Date: Sep. 24, 2026

(54) SYSTEMS AND METHODS FOR SWIR DUAL-BAND UNDER-DISPLAY FACE CAMERA

(71) Applicant: Corephotonics Ltd., Tel Aviv (IL)

(72) Inventor: Arie Gavriely, Tel Aviv (IL)

(21) Appl. No.: 19/476,190

(22) PCT Filed: Apr. 21, 2024
(86) PCT No.: PCT/IB2024/053876

§ 371 Date: Oct. 17, 2025

Related U.S. Application Data
(60) Provisional application No. 63/497,710, filed on Apr. 22, 2023.

(51) Int. Cl. G06V 40/16; G06V 10/10; G06V 10/141; G06V 10/143

(52) U.S. Cl. CPC G06V 40/166; G06V 10/141; G06V 10/143; G06V 10/17

(57) ABSTRACT

Mobile devices comprising a display, a short wave infrared (SWIR) illuminator configured and operational to illuminate a scene with light of at least two SWIR wavelength bands (SWIR-WBs), a SWIR under-display-camera (UDC) configured and operational to capture SWIR images in the at least two SWIR-WBs and to capture at least one SWIR image of a user, and an application processor configured to analyse the at least one SWIR image to identify an owner of the mobile device, to perform human skin detection and to unlock the mobile device if the owner is identified and if human skin is detected.

### CROSS REFERENCE TO RELATED APPLICATIONS

This is a 371 application from international patent application PCT/IB2024/053876 filed Apr. 21, 2024, which claims the benefit of U.S. provisional patent application No. 63/497,710 filed Apr. 22, 2023, which is incorporated herein by reference in its entirety.

### FIELD

Examples disclosed herein relate in general to biometric security and health monitoring methods and in particular to unlocking mobile devices with biometric security and health monitoring methods.

### BACKGROUND

Mobile handheld electronic devices (or simply “mobile devices”) such as smartphones, tablets, headsets, etc., which are configured to use biometric methods to be unlocked (or to be “opened”) are known. A popular unlocking biometric method is “face unlock” (or “face ID”). It uses images of a face of an owner of the mobile device to extract biometric face features that are unique (or characteristic) to an owner of the phone.

FIG. 1A shows a known exemplary mobile device 100 which is configured to support face unlock. Mobile device 100 has a rear surface 102 which is in general pointed away from a user. Mobile device 100 has a front surface 104 located opposite to rear surface 102 and which is in general pointed towards a user. Front surface 104 includes a first selfie (or “front”) camera 110 having a first selfie camera field-of-view (FOV₁) 112. First selfie camera 110 may be a known RGB camera including a RGB image sensor such as RGB image sensor 150. In the following, first selfie camera 110 is referred to as “selfie RGB camera” 110. Front surface 104 may also include a second selfie camera 120 having a second selfie camera FOV₂ 122. As shown, FOV₁ 112 and FOV₂ 122 overlap. Second selfie camera 120 may be a near-infrared (“NIR”) camera including a NIR image sensor as known in the art. In general, a NIR camera includes an illuminator. NIR refers here to a wavelength band (“WB”, or “wavelength region” or “spectral band”) of light which is invisible to the human eye and spanning approximately from a wavelength of 760 nm to 1000 nm. An invisible illumination such as NIR allows operation of second selfie camera 120 even in dark scenes without disturbing a human user. The NIR image sensor and the illuminator operate in a same WB, e.g. at around 940 nm. In some examples, operating the NIR image sensor together (and synchronized) with the illuminator allows for calculating a depth (or “3D”) map. In the following, the second selfie camera 120 is referred to as “selfie NIR camera” 120.

In some examples, selfie NIR camera 120 may be a depth camera including a depth sensor and operational to capture depth images. Front surface 104 may include a screen 124. An active area of screen 124 is marked. It is noted that an active area of screen 124 is limited by the presence of selfie RGB camera 110 and selfie NIR camera 120. Therefore, under-display cameras (UDCs) were introduced, which are located behind an active area of a screen such as screen 124. The presence of a UDC does not limit an active area of a screen. Rear surface 102 may include a multi-camera 126 as known in the art.

FIG. 1B shows a known method for face unlock numbered 130. In a step 132, a user approaches a mobile device (e.g. a smartphone) configured to perform face unlock. In a step 134, mobile device 100 captures a selfie image or a stream of selfie images including a face such as face 114 of the user. For simplicity, in the following we refer to (single) images only, but if not explicitly stated otherwise, it shall also include (or refer to) video streams of images. In a face unlock example, selfie RGB camera 110 and selfie NIR camera 120 are used to simultaneously capture a selfie RGB image and a selfie NIR image respectively. The simultaneous capturing is possible since FOV₁ 112 and FOV₂ 122 overlap. In an optional step 136, mobile device analyses the selfie RGB image to identify an owner of the mobile device. In a step 138, mobile device analyses the selfie NIR image to identify an owner of mobile device 100. In some examples, the selfie NIR image is fused (or “merged”) with the selfie RGB image to obtain a fused “RGB-NIR” image. The RGB-NIR image is then analysed to identify an owner of mobile device 100. The identification of the owner of mobile device includes in general extraction of a set of face features and comparison of the extracted set of face features with face features of the owner. In a step 140 and in case the comparison found that the extracted set of face features is identical with the face features of the owner, mobile device 100 is unlocked. In case the comparison found that the extracted set of face features differs from the face features of the owner, mobile device 100 remains locked. We refer to this face unlock example as “dual-camera face unlock” in examples where step 136 is performed, or as “NIR face unlock” in examples where step 136 is not performed.

A disadvantage of dual-camera face unlock and NIR face unlock is that it limits the active area of the mobile device screen. An advantage of dual-camera face unlock and NIR face unlock is that it provides a relatively high degree of security to the owner. “Relatively high degree of security” means here that a probability of incorrectly unlocking mobile device 100 is relatively low. Such incorrect unlocking would allow hacking of the mobile device. One method for hacking a mobile device is face spoofing. In some face spoofing examples, an image of the owner or a face mask resembling the owner may be positioned in FOV₁ and FOV₂. The relatively high degree of security is achieved by using additional image information. Here, the additional image information is NIR image information or depth image information. With NIR image information or depth image information, it is possible to distinguish between an image of the owner and the actual face of the owner. In other face spoofing examples, a face mask resembling the owner may be positioned in FOV₁ and FOV₂. In such examples, the NIR or depth image information may not be sufficient to distinguish between the face mask and the actual face of the owner.

There is need and it would be beneficial to having a dual-camera face unlock which allows for a large active screen area and that can provide a very high degree of security.

### SUMMARY

In various examples, there are provided mobile devices comprising a display, a SWIR illuminator configured and operational to illuminate a scene with light of at least two SWIR wavelength bands (SWIR-WBs), a SWIR UDC configured and operational to capture SWIR images in the at least two SWIR-WBs and to capture at least one SWIR image of a user, and an application processor (AP) configured to analyse the at least one SWIR image to identify an owner of the mobile device, to perform human skin detection and to unlock the mobile device if the owner is identified and if human skin is detected.

In some examples, the AP may be further configured to use the at least one SWIR image to perform skin health monitoring. In some examples, the AP may be further configured to use the at least one SWIR image to perform proximity sensing. In some examples, the AP may be further configured to use the at least one SWIR image to perform blood vessel sensing. In some examples, the at least two SWIR-WBs include a first SWIR-WB and a second SWIR-WB, and the human skin has a reflectivity in the first SWIR-WB that is at least 1.1 times larger than a reflectivity in the second SWIR-WB. In some examples, the at least two SWIR-WBs include a first SWIR-WB and a second SWIR-WB, and the human skin has a reflectivity in the first SWIR-WB that is at least 1.5 times larger than a reflectivity in the second SWIR-WB. In some examples, the reflectivity in the first SWIR-WB that is up to 10 times larger than the reflectivity in the second SWIR-WB.

In some examples, the at least two SWIR-WB include a first SWIR-WB in the range of 1050 nm-1250 nm and a second SWIR-WB in the range of 1250 nm-1550 nm. In some examples, the first SWIR-WB may be centered around a wavelength of 1060 nm and the second SWIR-WB may be centered around a wavelength of 1450 nm. In some examples, the first SWIR-WB may be centered around a wavelength of 1060 nm and the second SWIR-WB may be centered around a wavelength of 1350 nm. In some examples, the first SWIR-WB may be centered around a wavelength of 1060 nm and the second SWIR-WB may be centered around a wavelength of 1380 nm. In some examples, the first SWIR-WB may be centered around a wavelength of 1130 nm and the second SWIR-WB may be centered around a wavelength of1450 nm. In some examples, the first SWIR-WB may be centered around a wavelength of1130 nm and the second SWIR-WB may be centered around a wavelength of 1350 nm. In some examples, the first SWIR-WB may be centered around a wavelength of 1130 nm and the second SWIR-WB may be centered around a wavelength of 1380 nm.

In some examples, the SWIR UDC may be a depth camera, and the at least one SWIR image may be a depth image.

In some examples, the SWIR illuminator may illuminate a scene with light of three SWIR-WBs, and the SWIR UDC captures images of the three SWIR-WBs. In some examples, the SWIR illuminator may illuminate a scene with light of four SWIR-WBs, and the SWIR UDC captures images of the four SWIR-WBs.

In some examples, the SWIR UDC includes a SWIR image sensor that may include at least two colour filters. In some examples, the SWIR image sensor may be a clear image sensor. In some examples, the SWIR image sensor may include polarization sensitive pixels.

In some examples, the SWIR UDC may include a global colour filter which allows pass-through of light of the at least two SWIR-WBs.

In some examples, the display may comprise a first display area that has a polarization filter and a second display area that does not have a polarization filter, and the SWIR UDC may have an aperture operational to receive light that is located in the second display area. In some examples, the SWIR illuminator may have one or more aperture areas operational to emit light. In some examples, the SWIR illuminator may have five or more aperture areas operational to emit light. In some examples, the display comprises a first display area having a lower transparency than a second display area, and at least one of the one or more aperture areas is located in the second display area.

In some examples, the SWIR illuminator is operational to emit polarized light.

In some examples, the SWIR UDC may have an effective focal length in the range of 1 mm to 20 mm. In some examples, the SWIR UDC may have an effective focal length in the range of 1.5 mm to 7.5 mm.

In some examples, a light absorbing part of the SWIR image sensor may be made of Indium Gallium Arsenide. In some examples, a light absorbing part of the SWIR image sensor may be made of a quantum dot material. In some examples, a light absorbing part of the SWIR image sensor may be made of Germanium-on-Silicon.

In some examples, the mobile device has a front surface and a rear surface, the front surface is oriented parallel to the rear surface and located at an opposite side of the rear surface, and the SWIR UDC is included in the front surface. In some examples, the rear surface of the mobile device may include one or more additional cameras.

In some examples, the mobile device may be a smartphone. In some examples, the mobile device may be a tablet.

### BRIEF DESCRIPTION OF THE DRAWINGS

Non-limiting examples of examples disclosed herein are described below with reference to figures attached hereto that are listed following this paragraph. The drawings and descriptions are meant to illuminate and clarify examples disclosed herein and should not be considered limiting in any way. Like elements in different drawings may be indicated by like numerals. Elements in the drawings are not necessarily drawn to scale. In the drawings:

FIG. 1A shows schematically a known mobile device configured to perform face unlock;

FIG. 1B shows an example of a known method to perform face unlock;

FIG. 1C shows a known RGB image sensor;

FIG. 2A shows a graph plotting human skin reflectance versus wavelength of light;

FIG. 2B shows an example of a tetra-band SWIR sensitive image sensor disclosed herein;

FIG. 2C shows an example of a dual-band SWIR sensitive optical system comprising an image sensor and a global colour filter disclosed herein;

FIG. 3A shows schematically an example of a mobile device configured to perform face unlock disclosed herein;

FIG. 3B shows parts of a known display;

FIG. 3C shows a known SWIR illuminator;

FIG. 3D shows an example of a display-SWIR illuminator configuration disclosed herein including the known display of FIG. 3B and the known SWIR illuminator of FIG. 3C;

FIG. 4 shows an example of a method perform face unlock disclosed herein;

FIG. 5 shows schematically an example of a mobile device configured to perform face unlock disclosed herein.

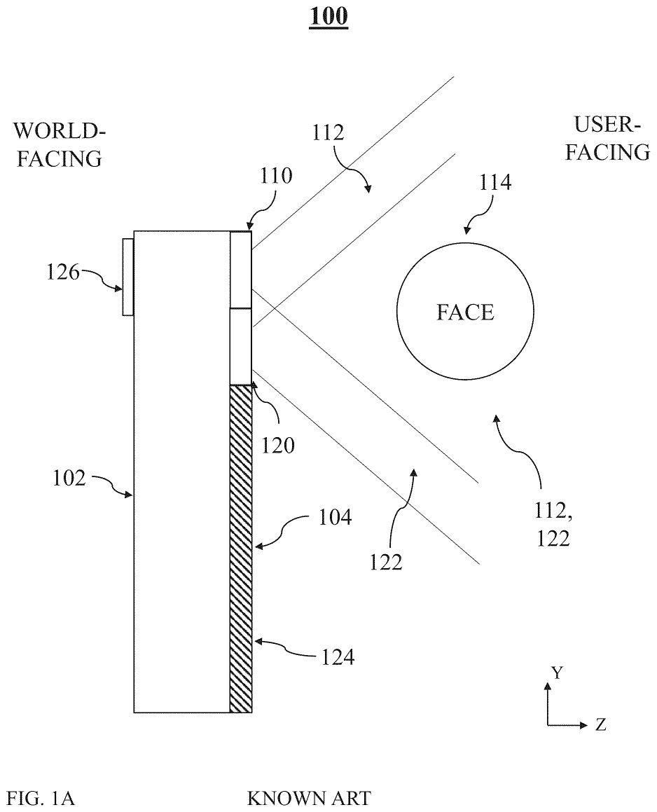

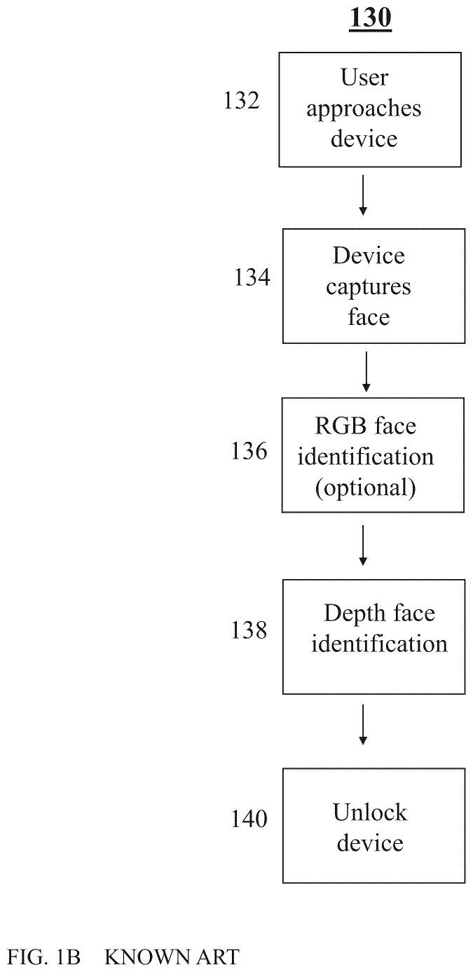

### DETAILED DESCRIPTION

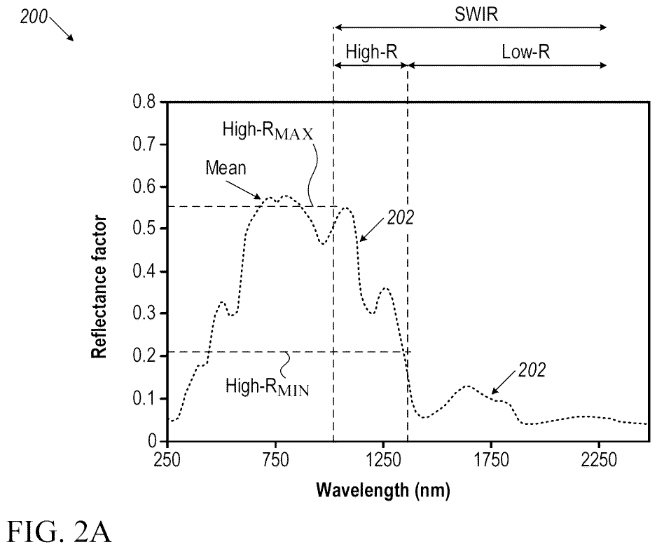

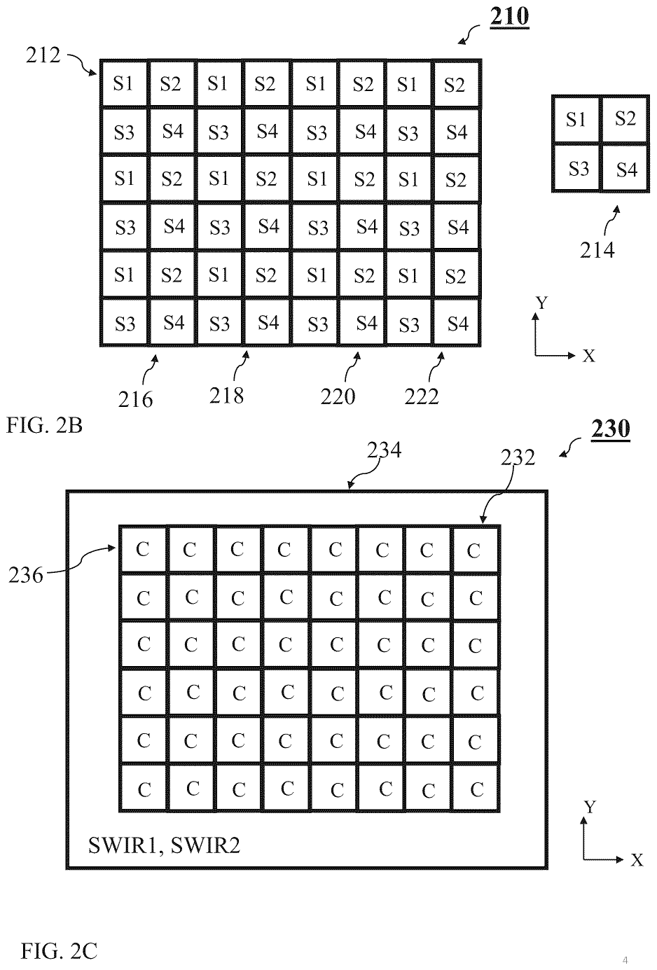

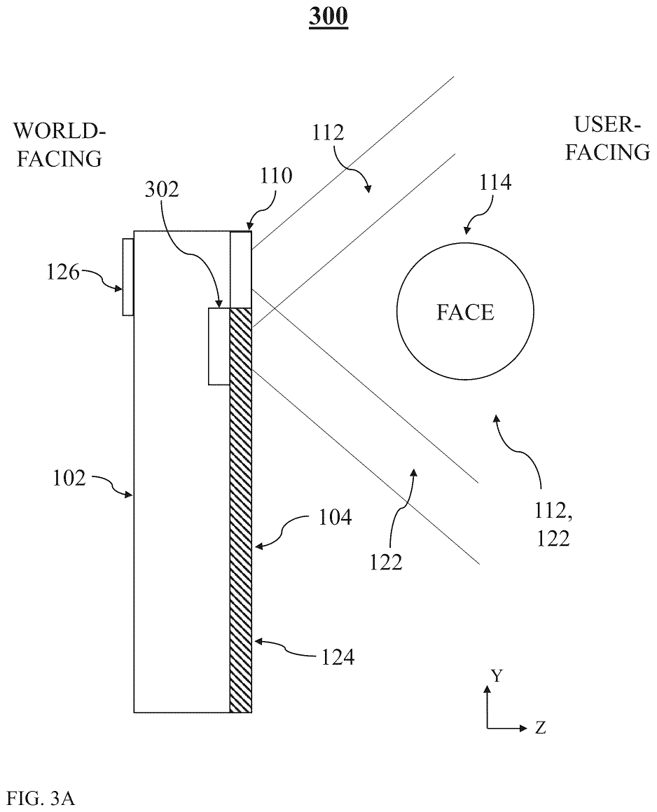

FIG. 2A shows a graph 200 that plots skin reflectance of human skin on the vertical axis versus wavelength of light in nanometers (nm) on the horizontal axis. Graph 200 shows a curve 202 that represents values of skin reflectance for several wavelengths of light. Note particularly the part of graph 200 that includes wavelengths in the short wave infrared (SWIR) wavelength band (“SWIR-WB”), i.e. values in a region spanning about 1000 nm-2000 nm or more. In the SWIR-WB, graph 200 has a first SWIR-WB which shows relatively high reflectance and which is marked accordingly “High-R”, and a second SWIR-WB which shows relatively low reflectance and which is marked accordingly “Low-R”. Exemplarily, here we define High-R by a minimum reflectance value (“High-R_{MIN}”) of about 0.2. SWIR-WBs associated with a reflectance of 0.2 or higher belong to the High-R region, while SWIR-WBs associated with a reflectance of 0.2 or lower belong to the Low-R region. A highest reflectance value (“High-R_{MAX}”) is about 0.55. That is, High-R region includes reflectance values ranging from 0.2-0.55 and Low-R region includes reflectance values smaller than 0.2. As seen, reflectance values in the High-R region are about 1.5-10 larger than reflectance values in the Low-R region. In other examples, reflectance values in the High-R region may be about 1.1 times larger or 1.2 times larger than reflectance values in the Low-R region.

In other examples, High-R region and Low-R region may be defined differently. For example, High-R_{MIN} may be about 0.175, or 0.25 or 0.3 or 0.4. In these examples, the High-R region may include reflectance values in the ranges 0.175-0.55, 0.25-0.55, 0.3-0.55 and 0.4-0.55 respectively, and the Low-R region may include reflectance values smaller than 0.175, 0.25, 0.3 and 0.4 respectively.

FIG. 2B shows a SWIR image sensor numbered 210 disclosed herein in a top view. Included in a SWIR camera, an optical axis of the SWIR camera is oriented perpendicular to SWIR image sensor 210, i.e. perpendicular to the shown x-y axes. SWIR image sensor 210 includes a plurality of single pixels like single pixel 212, and a plurality of pixel units like a pixel unit 214. Pixel unit 214 includes a first SWIR pixel (marked “S1”), a second SWIR pixel (marked “S2”), a third SWIR pixel (marked “S3”) and a fourth SWIR pixel (marked “S4”). S1, S2, S3 and S4 pixel are respectively covered by a first, a second, a third, and a fourth wavelength band filter (WBF). The first, second, third and fourth WBFs let pass through, respectively, light of a first SWIR-WB (“SWIR1”), a second SWIR-WB (“SWIR2”), a third SWIR-WB (“SWIR3”), and a fourth SWIR-WB (“SWIR4”). As of the four WBFs, to SWIR image sensor 210 is referred to as tetra-band SWIR image sensor.

In some examples, SWIR1 and SWIR2 may be both located in the High-R region, and SWIR3 and SWIR4 may be both located in the Low-R region. In some examples, only two different WBFs are present, for example SWIR1=SWIR3 and SWIR2=SWIR4 or any other permutation. To such an image sensor is referred to as “dual-band image sensor”.

A light absorbing part of a SWIR pixel is made of a material that has a relatively high quantum efficiency in a relevant SWIR-WB range, For example Indium Gallium Arsenide (InGaAs), Germanium-on-Silicon (Ge-on-Si), or a suitable quantum dot (QD) material. Pixel unit 214 represents the smallest pixel unit that can be used as a building block to construct (or to assemble) SWIR image sensor 210. As shown, SWIR image sensor 210 can be formed by repeating pixel units such as pixel unit 214, as shown for pixel units 216, 218, 220 and 222. In some examples, a single pixel like single pixel 212 may be covered with a polarization sensitive filter, the pixel being then a “polarization sensitive pixel”. A polarization sensitive pixel may be operational to measure a degree of linear polarization (“DOLP”), an angle of linear polarization (“AOLP”), a degree of circular polarization (“DOCP”), an angle of circular polarization (“AOCP”), etc. Integrated in a camera, a SWIR sensor including polarization sensitive pixels allows for sensing a polarization state of light entering the camera, as known in the art. SWIR1, SWIR2, SWIR3 and SWIR4 may each have a wavelength bandwidth of about 5 nm-200 nm or more. This means that they allow passing of light in a WB of about ±2.5 nm ±100 nm around a particular “center” SWIR wavelength. That is, a SWIR-WB is “centered” around a center SWIR wavelength. In the following examples, a center SWIR wavelength is given.

In dual-band SWIR image sensors for human skin detection, one SWIR-WB (e.g. SWIR1) may be located in a High-R region, and a second SWIR-WB (e.g. SWIR2) may be located in a Low-R region. For example, SWIR 1 may be in the WB of 1050 nm to 1300 nm, e.g. 1060 nm or 1150 nm or 1250 nm, and SWIR2 may be in the WB of 1300 nm to 2000 nm, e.g. 1350 nm or 1380 nm or 1450 nm or 1500 nm or 1600 nm. In other examples, SWIR1 may be in the WB of 1100 nm to 1200 nm, e.g. 1130 nm or 1150 nm, and SWIR2 may be in the WB of 1300 nm to 1500 nm, e.g. 1350 nm or 1380 nm or 1450 nm.

In some examples, SWIR image sensor 210 may be a SWIR depth sensor, i.e. a depth sensor operating in the SWIR region. A depth camera may include a SWIR depth sensor and one or more SWIR illuminators. Operating the SWIR depth sensor together (and synchronized) with the one or more SWIR illuminators allows for calculating a depth (or “3D”) map. The SWIR depth sensor and the one or more SWIR illuminators operate in same wavelength regions. A depth camera may use methods as known in the art, for example “indirect time-of-flight” (“i-ToF”), “direct time-of-flight” (“d-ToF”), “structured light”, etc.

In some examples, a first illuminator may operate (or “emit light”) at SWIR-WB SWIR1 and a second illuminator may operate at SWIR-WB SWIR2.

In other examples, one illuminator may operate at a SWIR-WB that covers both SWIR1 and SWIR2.

In yet other examples, a first illuminator may operate at SWIR1, a second illuminator may operate at SWIR2, a third illuminator may operate at SWIR3, and a fourth illuminator may operate at SWIR4.

In yet other examples, a first illuminator may operate at a SWIR-WB that covers both SWIR1 and SWIR2, and a second illuminator may operate at a SWIR-WB that covers both SWIR3 and SWIR4.

In yet other examples, one illuminator may operate at a SWIR-WB that covers all of SWIR1, SWIR2, SWIR3 and SWIR4.

FIG. 2C shows a SWIR image sensor system numbered 230 disclosed herein in a top view. Included in a SWIR camera, an optical axis of the SWIR camera is oriented perpendicular to SWIR image sensor system 230, i.e. perpendicular to the x-y axes shown. SWIR image sensor system 230 includes a SWIR image sensor 232 and a global colour filter (CF) 234. “Global” refers to the fact that global CF 234 filters light impinging on all pixels included in SWIR image sensor 232. SWIR image sensor 232 includes a plurality of single pixels like single pixels 236. SWIR image sensor 232 and global CF 234 are oriented parallel to each other. Included in a camera, global CF 234 is located (or positioned) at an object-side of SWIR image sensor 232, meaning that light propagating from a scene first passes global CF 234 before it is absorbed by SWIR image sensor 232. All pixels of SWIR image sensor 232 are “clear” (“C”) pixels. A clear pixel does not filter any WB (or colour). Global CF 234 may be operational to let pass through light of a SWIR-WB SWIR1 and light of a SWIR-WB SWIR2. In some examples and as mentioned, SWIR1 may be located in the High-R region, and SWIR2 may be located in the Low-R region. In some examples, a first illuminator may operate at SWIR1 and a second illuminator may operate at SWIR2. In some examples, the first illuminator and the second illuminator may be operated sequentially. For example, first illuminator may illuminate the scene at SWIR1, and a first SWIR image may be captured, which includes mainly signal from SWIR1. Then, second illuminator may illuminate the scene at SWIR2, and a second SWIR image may be captured, which includes mainly signal from SWIR2. Human skin detection can be performed by comparing the first and the second image.

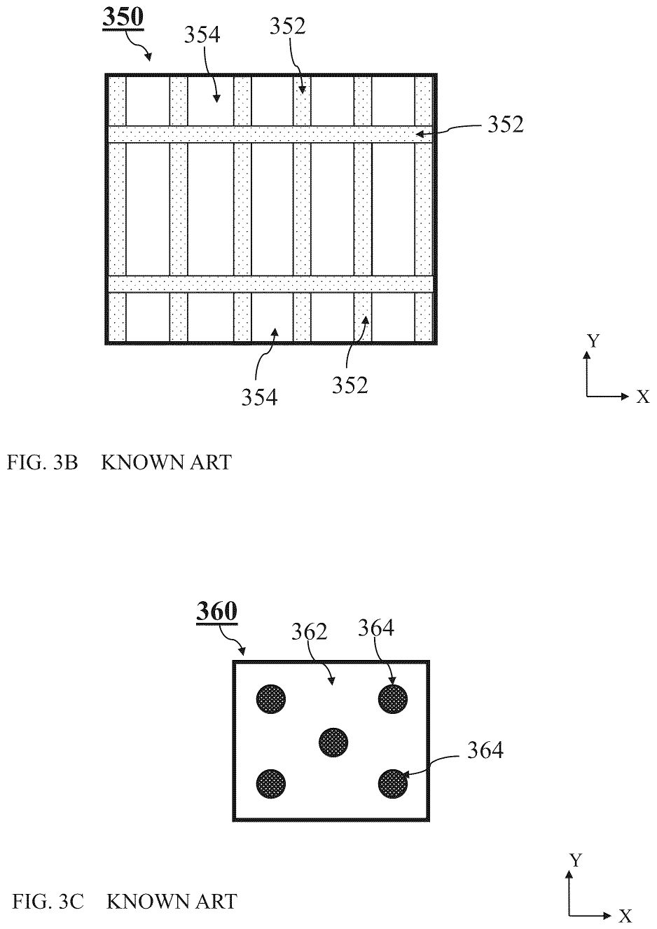

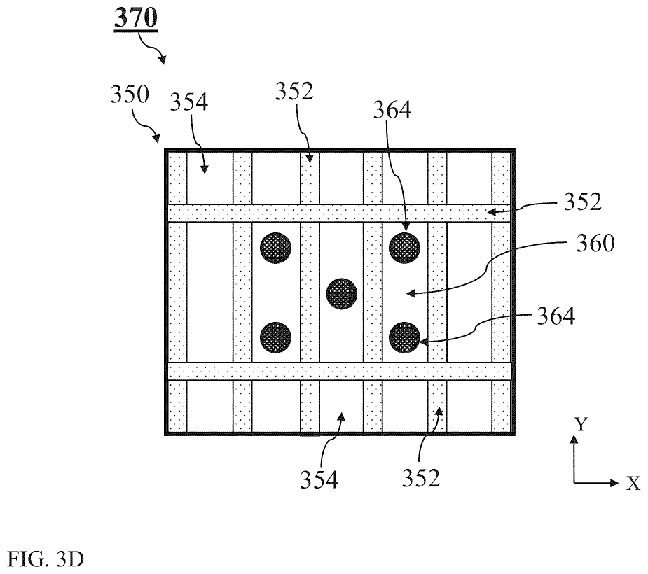

FIG. 3A shows an example of a mobile device numbered 300 disclosed herein. Mobile device 300 is configured to support face unlock and health monitoring as disclosed herein. Mobile device 300 is identical to mobile device 100, except for a second selfie camera 302. Second selfie camera 302 is a SWIR under-display camera (“UDC”). Second selfie camera 302 includes a SWIR image sensor such as SWIR image sensor 210 or a SWIR image sensor system such as SWIR image sensor system 230, and one or more illuminators. Note that an active area of screen 124 is not limited by the presence of second selfie camera 302. We note that a screen such as screen 124 is in general more transparent in SWIR-WBs than in a RGB WB or in a NIR WB. This means that when placed behind a display (or “screen”), or in other words, when used as UDC, a SWIR camera harvests more SWIR light compared to a RGB camera assuming same optical power impinging on a display region where the respective UDC is located.

It is known that many materials have relatively strong absorption bands in SWIR-WBs, which often are characteristic for a particular material. Therefore, it is beneficial to perform spectroscopic measurements in a SWIR-WB. A SWIR camera such as second selfie camera 302 including a SWIR image sensor and one or more SWIR illuminators may in addition be operational to perform spectroscopic measurements.

In a first example (“Skin health monitoring”), second selfie camera 302 may be used to capture a face of a user not just for face unlock, but also for monitoring a health of a skin of the face of the user. For example, the health of a skin of the face of the user may be based on measuring a humidity (or moisture) level of a skin by means of a spectroscopic measurement.

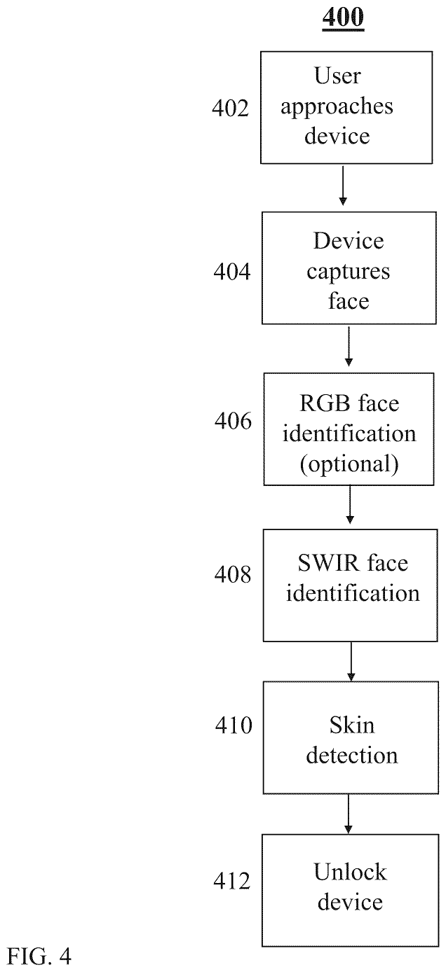

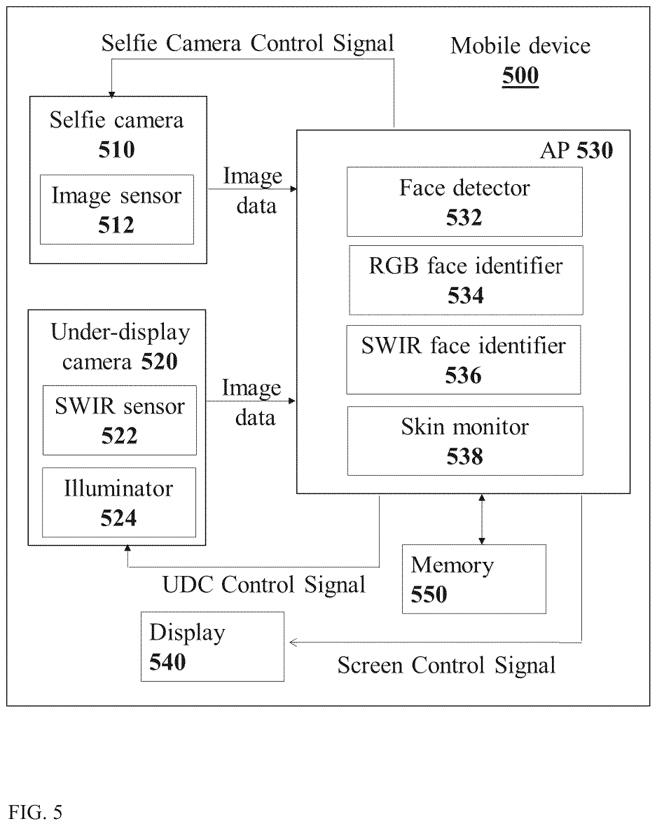

In a second example (“Skin detection”), second selfie camera 302 may be used to capture a face of a user to provide a face unlock with a very high degree of security. For example, based on the known spectroscopic behaviour of human skin (see FIG. 2A), from image data captured by second selfie camera 302 one may be able to distinguish between human skin and another material, for example plastic used in a face mask. Based on this, one may be able to detect face spoofing attacks using a face mask, leading to a face unlock with a very high degree of security (see FIG. 4). The very high degree of security is achieved by using additional image information. Here, the additional image information is spectroscopic image information.

In a third example (“Proximity sensing”), second selfie camera 302 may be a depth camera and used to estimate a distance (or proximity) of an object.

In a fourth example (“Blood vessel sensing”), second selfie camera 302 may be used to image blood vessels of a user, e.g. blood vessels in the palm, in the face, or in the hand of a user.

FIG. 3B shows parts of a known display numbered 350 operational for use in a mobile device including a UDC. Parts of display 350 include a first display area 352 and a second display area 354. First display area 352 has a first degree of transparency. Second display area 354 has a second degree of transparency higher than the first degree of transparency. In other words, second display area 354 is more transparent than first display area 352.

FIG. 3C shows a known SWIR illuminator 360 operational for use in a UDC. Illuminator 360 has an inactive area 362 and one or more active aperture areas. Here, illuminator 360 has five aperture areas, with two exemplary aperture areas marked 364. Only the aperture areas are operational to emit light, while inactive area 362 is not operational to emit light. In other words, all light emitted by illuminator 360 is emitted from the active aperture areas.

FIG. 3D shows an example of a display-SWIR illuminator configuration 370 as disclosed herein. Display-SWIR illuminator configuration 370 may include parts of display 350 and SWIR illuminator 360. Referring to a z-axis perpendicular to the shown x-y axes, SWIR illuminator 360 is positioned below parts of display 350. Display-SWIR illuminator configuration 370 is beneficial for use in a mobile device including a SWIR UDC (FIG. 5), as it allows for a relatively large amount of light to pass through display 350 and illuminate a scene. As shown, parts of a display 350 and SWIR illuminator 360 may be positioned relative to each other in the x-y plane so that the aperture areas of SWIR illuminator 360 overlap with second display area 354, such that a relatively large amount of light can pass through display 350. This is beneficial in terms of power consumption and signal-to-noise (SNR) ratio of a UDC including display-SWIR illuminator configuration 370. We note that this advantage is not limited to wavelengths of light in SWIR, but it is present also in NIR or in the visible. In other examples, a display-illuminator configuration such as display-SWIR illuminator configuration 370 may operate in the NIR.

In some examples, a display may include a polarization filter which is operational to avoid back reflection of light of a scene onto the eyes of a user. In some examples, the polarization sensitive filter may be locally removed, for example at a position where a SWIR UDC has an aperture operational to receive light, or at a position where a SWIR illuminator has an aperture area operational to emit light. That is, there is a first display area that has a polarization filter and a second display area that does not have a polarization filter, wherein the SWIR UDC has an aperture operational to receive light, and wherein the aperture is located in the second display area.

In other examples, a SWIR illuminator may be a polarized SWIR illuminator. In some of these examples, the polarization of the SWIR illuminator may be identical to a polarization of a polarization filter included in the display, so that light from the SWIR illuminator can pass the polarization filter with a relatively low loss of light, which is beneficial in terms of signal-to-noise ratio. We note that a polarized illuminator can be advantageous also in other WBs, e.g. in NIR or in the visible. In other examples, a NIR illuminator may be a polarized NIR illuminator.

FIG. 4 shows an example of a method for face unlock numbered 400 as disclosed herein. In a step 402, a user approaches a mobile device (e.g. a smartphone) such as mobile device 300 configured to perform face unlock. In a step 404, a mobile device such as mobile device 400 captures a selfie image including a face such as face 114 of the user. In a face unlock example, selfie RGB camera 110 and second selfie camera 302 are used to simultaneously capture a selfie RGB image and a selfie SWIR image respectively. In an optional step 406, mobile device analyses the selfie RGB image to identify an owner of the mobile device. In a step 408, mobile device analyses the selfie SWIR image to identify an owner of mobile device 300. In some examples, selfie SWIR image may be a depth image. In other examples, the selfie SWIR image is fused (or “merged”) with the selfie RGB image to obtain a fused “RGB-SWIR” image. The RGB-SWIR image is then analysed to identify an owner of mobile device 300. For identifying an owner of mobile device 300, in general a set of face features is extracted, and the set of face features is compared to the face features of the owner.

In a step 410, skin detection is performed.

In a step 412 and in case the comparison found that a set of face features is identical with the face features of an owner of mobile device 300, and in addition in case that human skin was detected, mobile device 300 is unlocked. In case the comparison found that a set of face features differs from the face features of an owner of mobile device 300, or that instead of human skin another material is detected, mobile device 300 is not unlocked.

FIG. 5 shows schematically an example of a mobile device (for example, a smartphone) numbered 500 and configured to perform face unlock disclosed herein (for example according to method 400). Mobile device 500 comprises a first RGB selfie camera 510 having a first selfie camera FOV and including an image sensor 512. Mobile device 500 further comprises a second selfie camera 520 which is a SWIR UDC camera having a second selfie camera FOV. Second selfie camera 520 includes a SWIR image sensor 522 and one or more SWIR illuminators 524. Optionally, mobile device 500 may further comprise a second camera, e.g. a multi-camera as known in the art. In general, first RGB selfie camera 510 and second selfie camera 520 may be positioned at (or included in) a front surface of mobile device 500, and the multi-camera may be positioned at (or included in) a rear surface of mobile device 500 which is located opposite to the front surface. Second selfie camera 520 may exemplarily have an effective focal length (“EFL”) in the range of 1 mm to 20 mm, in the range of 1.5 mm to 7.5 mm, etc.

Mobile device 500 further comprises an application processor (AP) 530. AP 530 may include a face detector 532, e.g. configured to perform face detection, an (optional) RGB face identifier 534, e.g. configured to identify a face of an owner of mobile device 500 in a RGB image, a SWIR face identifier 536, e.g. configured to identify a face of an owner of mobile device 500 in a SWIR image, and a skin monitor 538. Skin monitor 538 may be operational to perform skin detection and skin health monitoring as described above.

Mobile device 500 further comprises a display 540 and a memory 550. Second selfie camera 520 is located under (or behind) display 540. Memory 550 may e.g. be used to store a set of face features of an owner of mobile device 500 as well as a spectroscopic database for skin detection and skin health monitoring.

In other examples, second selfie camera 520 as disclosed herein may be used behind another display not included in a mobile device. For example, second selfie camera 520 may be used behind a display used in a vehicle to identify an owner, or more general in an Automotive application. In another example, second selfie camera 520 may be used in a display used in a television or in a computer to identify an owner, or more general in a consumer electronics application.

While this disclosure has been described in terms of certain examples and generally associated methods, alterations and permutations of the examples and methods will be apparent to those skilled in the art. The disclosure is to be understood as not limited by the specific examples described herein, but only by the scope of the appended claims.

All references mentioned in this specification are herein incorporated in their entirety by reference into the specification, to the same extent as if each individual reference was specifically and individually indicated to be incorporated herein by reference. In addition, citation or identification of any reference in this application shall not be construed as an admission that such reference is available as prior art to the present application.

1. A mobile device, comprising:
a display;
a short wave infrared (SWIR) illuminator configured and operational to illuminate a scene with light of at least two SWIR wavelength bands (SWIR-WBs);
a SWIR under-display-camera (UDC) configured and operational to capture SWIR images in the at least two SWIR-WBs and to capture at least one SWIR image of a user; and
an application processor (AP) configured to analyse the at least one SWIR image to identify an owner of the mobile device, to perform human skin detection and to unlock the mobile device if the owner is identified and if human skin is detected,
wherein the SWIR illuminator has one or more aperture areas operational to emit light, and
wherein the display comprises a first display area having a lower transparency than a second display area, and wherein at least one of the one or more aperture areas is located in the second display area.

2. (canceled)

3. (canceled)

4. (canceled)

5. The mobile device of claim 1, wherein the at least two SWIR-WBs include a first SWIR-WB and a second SWIR-WB, and wherein the human skin has a reflectivity in the first SWIR-WB that is at least 1.1 times larger than a reflectivity in the second SWIR-WB.

6. The mobile device of claim 1, wherein the at least two SWIR-WBs include a first SWIR-WB and a second SWIR-WB, and wherein the human skin has a reflectivity in the first SWIR-WB that is at least 1.5 times larger than a reflectivity in the second SWIR-WB.

7. The mobile device of claim 6, wherein the reflectivity in the first SWIR-WB that is up to 10 times larger than the reflectivity in the second SWIR-WB.

8. The mobile device of claim 1, wherein the at least two SWIR-WB include a first SWIR-WB in the range of 1050 nm-1250 nm and a second SWIR-WB in the range of 1250 nm-1550 nm.

9. The mobile device of claim 8, wherein the first SWIR-WB may be centered around a wavelength of 1060 nm and the second SWIR-WB is may be centered around a wavelength of 1450 nm.

10. The mobile device of claim 8, wherein the first SWIR-WB may be centered around a wavelength of 1060 nm and the second SWIR-WB may be centered around a wavelength of 1350 nm.

11. The mobile device of claim 8, wherein the first SWIR-WB may be centered around a wavelength of 1060 nm and the second SWIR-WB may be centered around a wavelength of 1380 nm.

12. The mobile device of claim 8, wherein the first SWIR-WB may be centered around a wavelength of 1130 nm and the second SWIR-WB may be centered around a wavelength of1450 nm.

13. The mobile device of claim 8, wherein the first SWIR-WB may be centered around a wavelength of 1130 nm and the second SWIR-WB may be centered around a wavelength of 1350 nm.

14. The mobile device of claim 8, wherein the first SWIR-WB may be centered around a wavelength of 1130 nm and the second SWIR-WB may be centered around a wavelength of 1380 nm.

15. (canceled)

16. (canceled)

17. (canceled)

18. The mobile device of claim 1, wherein the SWIR UDC includes a SWIR image sensor, and wherein the SWIR image sensor includes at least two colour filters.

19. The mobile device of claim 1, wherein the SWIR UDC includes a SWIR image sensor, and wherein the SWIR image sensor is a clear image sensor.

20. (canceled)

21. The mobile device of claim 1, wherein the display comprises a first display area that has a polarization filter and a second display area that does not have a polarization filter, wherein the SWIR UDC has an aperture operational to receive light, and wherein the aperture is located in the second display area.

22. (canceled)

23. The mobile device of claim 1, wherein the SWIR illuminator has five or more aperture areas operational to emit light.

24. (canceled)

25. The mobile device of claim 1, wherein the SWIR illuminator is operational to emit polarized light.

26. The mobile device of claim 1, wherein the SWIR UDC includes a SWIR image sensor, and wherein the SWIR image sensor includes polarization sensitive pixels.

27. (canceled)

28. (canceled)

29. (canceled)

30. (canceled)

31. (canceled)

32. The mobile device of claim 1, wherein the mobile device has a front surface and a rear surface, wherein the front surface is oriented parallel to the rear surface, wherein the front surface is located at an opposite side of the rear surface, and wherein the SWIR UDC is included in the front surface of the mobile device.

33. (canceled)

34. The mobile device of claim 1, wherein the mobile device is a smartphone.

35. The mobile device of claim 1, wherein the mobile device is a tablet.
